(19) United States
(12) Patent Application Publication
(10) Pub. No.: US 2018/0207550 A1
(43) Pub. Date: Jul. 26, 2018

(54) APPARATUS AND METHOD FOR GRAVITY SEPARATION AND OIL AND GAS PRODUCTION SYSTEM

(71) Applicant: GENERAL ELECTRIC COMPANY, Schenectady, NY (US)

(72) Inventors: Rihua XIONG, Shanghai (CN); Chengqian ZHANG, Shanghai (CN)

(73) Assignee: GENERAL ELECTRIC COMPANY, Schenectady, NY (US)

(21) Appl. No.: 15/578,400

(22) PCT Filed: May 26, 2016
(86) PCT No.: PCT/US2016/034365

§ 371 Date: Nov. 30, 2017

(30) Foreign Application Priority Data
Jun. 4, 2015 (CN) 201510304772.9

(51) Int. Cl. B01D 17/02; B01D 21/00; C02F 1/40; E21B 43/34

(52) U.S. Cl. CPC B01D 17/0214; B01D 21/0087; C02F 2103/10; E21B 43/34; C02F 1/40

(57) ABSTRACT

An apparatus for gravity separation, including: an inlet for receiving a separation stream; a separating section in communication with the inlet, for separating the separation stream and providing a first product stream and a second product stream, and including: a first separating junction including a first Input conduit, a first output conduit and a second output conduit, a second separating junction in communication with the first output conduit and including a third output conduit and a fourth output conduit, and a third separating junction in communication with the second output conduit and including a fifth output conduit and a sixth output conduit; a first outlet for outputting the first product stream; and a second outlet for outputting the second product stream. A method for gravity separation, and an oil and gas production system and method including the apparatus and method.

### TECHNICAL FIELD

Embodiments of the present invention relate to an apparatus and a method for gravity separation, and an oil and gas production system and a method comprising the same.

### BACKGROUND OF THE INVENTION

Material separation is demanded in various fields. For example, in the oil and gas industry, the exploited oil and gas, generally containing the combination of liquids (such as oil and water), solids and/or gases, needs to be separated during the process of production, so as to obtain the final products.

The existing apparatuses and methods separate materials with the gravity, but has poor separation effects and cannot meet various different requirements.

Thus, a new apparatus and method for gravity separation, and an oil and gas production system and method comprising the same, are needed.

### SUMMARY OF INVENTION

In an aspect, the embodiment of the present invention relates to an apparatus for gravity separation, comprising: an inlet for receiving a separation stream; a separating section in communication with the inlet, for separating the separation stream and providing a first product stream and a second product stream, and comprising a first separating junction comprising a first input conduit, a first output conduit and a second output conduit, a second separating junction in communication with the first output conduit and comprising a third output conduit and a fourth output conduit, and a third separating junction in communication with the second output conduit and comprising a fifth output conduit and a sixth output conduit; a first outlet for outputting the first product stream; and a second outlet for outputting the second product stream.

In another aspect, the embodiment of the present invention relates to an oil and gas production system comprising the apparatus for gravity separation according an embodiment of the present invention.

In another aspect, the embodiment of the present invention relates to a method for gravity separation, comprising: inputting a separation stream comprising a first material with a first density and a second material with a second density higher than the first density into an inlet of the apparatus according to an embodiment of the present invention; separating the separation stream in the separating section and providing a first product stream and a second product stream comprising less of the first material and more of the second material than the first product stream; outputting the first product stream from the first outlet; and outputting the second product stream from the second outlet.

In another aspect, the embodiment of the present invention relates to an oil and gas production method comprising the method for gravity separation according an embodiment of the present invention.

### BRIEF DESCRIPTION OF THE DRAWINGS

The features, aspects and advantages of present invention can be understood better through reading the following description and referring to the accompanying drawings, in which:

FIGS. 1, 2 and -3 are schematic views of the apparatuses according to the embodiments of the present invention.

### DETAILED DESCRIPTION

Unless defined otherwise, all the technical or scientific terms used in the Claims and the Description should have the same meanings as commonly understood by one of ordinary skilled in the art to which the present invention belongs. The terms “comprises”, “comprising”, “includes”, “including” and the like mean that the element or object in front of the “comprises”, “comprising”, “includes” and “including” cover the elements or objects and their equivalents illustrated following the “comprises”, “comprising”, “includes” and “including”, but do not exclude other elements or objects.

The approximate terms in the present invention used for modifying numbers, indicates that the present invention are not limited to the specific numbers, but comprises the acceptable and corrected portions near the numbers, which would not change the relative basic functions. Correspondingly, the terms such as “approximately”, “about”, “more or less” modifying a number, means that the present invention are not limited to the exact number. In some embodiments, the approximate terms may correspond to the precision of a measuring instrument. The ranges of number in the present invention may be incorporated and exchangeable, and unless defined otherwise, a number range includes all the sub-ranges of numbers contained therein.

In the Description and the Claims, the singular and plural of an item are not limited, unless being defined otherwise. The terms “first”, “second”, “third”, “fourth” and the like in the Description and the Claims do not mean any sequential order, number or importance, but are only used for distinguishing different components or embodiments.

Unless defined otherwise explicitly in the context, the term “or” does not means exclusiveness, but indicates that at least one of the mentioned item exists, and comprises the situation that the combination of the mentioned items may exist.

The terms “some embodiments” and the like in the Description of the present invention indicates that one certain element (such as feature, structure and/or characteristic) related to the present invention is included in at least one embodiment of the present invention, and may or may not be included in other embodiment(s). Additionally, it should be understood that the elements in the present invention may be combined in any suitable way.

Hereinafter, the embodiments would be described with reference to the drawings and the well-known function and structure would not be described in details, so as to avoid obscurity resulting from unnecessary details.

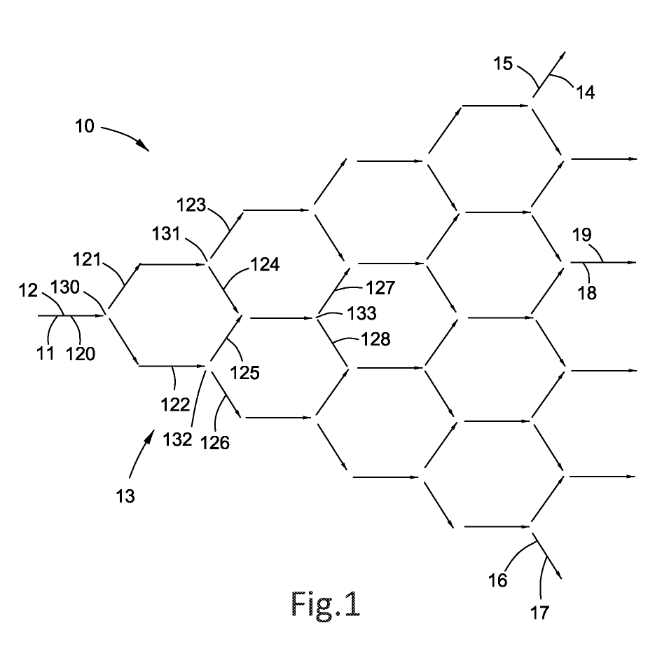

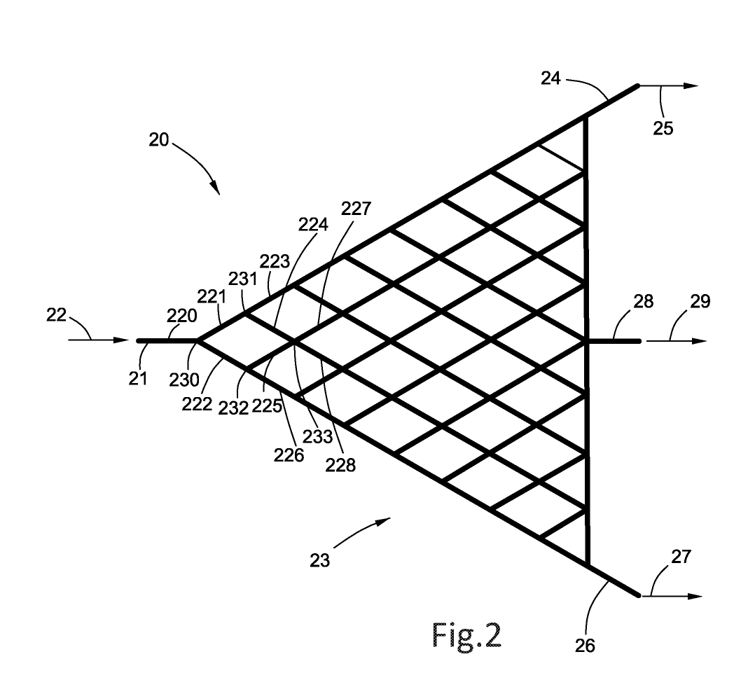

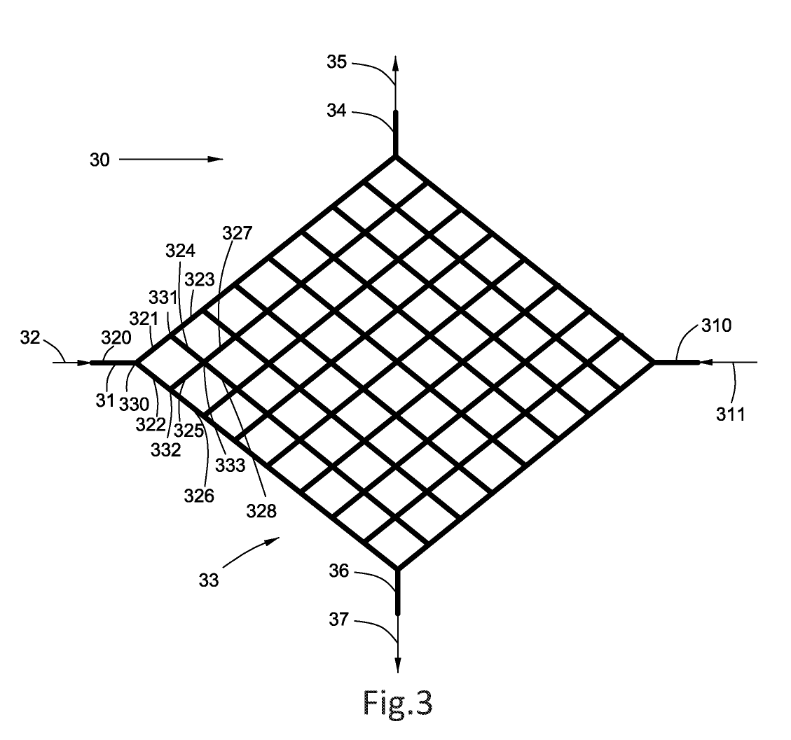

FIGS. 1-3 are schematic views of the apparatuses 10, 20, 30 for gravity separation according to the embodiments of the present invention. The apparatus 10, 20, 30 comprises: an inlet 11, 21, 31 for receiving a separation stream 12, 22, 32; a separating section 13, 23, 33 in communication with the inlet 11, 21, 31, for separating the separation stream 12, 22, 32 and providing a first product stream 15, 25, 35 and a second product stream 17, 27, 37, and including a first separating junction 130, 230, 330 including a first input conduit 120, 220, 320, a first output conduit 121, 221, 321 and a second output conduit 122, 222, 322, a second separating junction 131, 231, 331 in communication with the first output conduit 121, 221, 321 and including a third output conduit 123, 223, 323 and a fourth output conduit 124, 224, 324, and a third separating junction 132, 232, 332 in communication with the second output conduit 122, 222, 322 and including a fifth output conduit 125, 225, 325 and a sixth output conduit 126, 226, 326; a first outlet 14, 24, 34 for outputting the first product stream 15, 25, 35; and a second outlet 16, 26, 36 for outputting the second product stream 17, 27, 37.

The term “separation stream” and the like mentioned in embodiments of the present invention means the material combination to be separated with gravity. In some embodiments, the separation stream 12, 22, 32 includes solids, liquids, gases or any combination thereof. In some embodiments, the separation stream 12, 22, 32 includes two or more different liquids, such as water and oil.

In some embodiments, the separation stream 12, 22, 32 containing a first and second material with a first and second density respectively, enters the apparatus 10, 20, 30 via the inlet 11, 21, 31, for the separation of the first and second materials in the separating section 13, 23, 33.

In some embodiments, the first separating junction 130, 230, 330 is connected to the inlet 11, 21, 31, and the separation stream 12, 22, 32 passes through the inlet 11, 21, 31 and the first input conduit 120, 220, 320, and is separated into two branches, on the basis of gravity and according to the difference of the first and second density, which are output through the first output conduit 121, 221, 321 and the second output conduit 122, 222, 322 respectively.

In some embodiments, the second density is higher than the first density, and the second output conduit 122, 222, 322 is lower than the first output conduit 121, 221, 321 in the vertical direction. The first material flowing into the second output conduit 122, 222, 322 is less than that flowing into the first output conduit 121, 221, 321, while the second material flowing into the second output conduit 122, 222, 322 is more than that flowing into the first output conduit 121, 221, 321.

The second separating junction 131, 231, 331 is in communication with the first output conduit 121, 221, 321 of the first separating junction 130, 230, 330, and the material combination from the first output conduit 121, 221, 321 is further separated into two branches, on the basis of gravity and according to the difference of the first and second density, which are output through the third output conduit 123, 223, 323 and the fourth output conduit 124, 224, 324 respectively. In some embodiments, the first output conduit 121, 221, 321 is the input conduit of the second separating junction 131, 231, 331.

In some embodiments, the third output conduit 123, 223, 323 is higher than the fourth output conduit 124, 224, 324 in the vertical direction. The first material flowing into the third output conduit 123, 223, 323 is more than that flowing into the fourth output conduit 124, 224, 324, while the second material flowing into the third output conduit 123, 223, 323 is less than that flowing into the fourth output conduit 124, 224, 324.

The third separating junction 132, 232, 332 is in communication with the second output conduit 122, 222, 322 of the first separating junction 130, 230, 330, and the material combination from the second output conduit 122, 222, 322 is further separated into two branches, on the basis of gravity and according to the difference of the first and second density, which are output through the fifth output conduit 125, 225, 325 and a sixth output conduit 126, 226, 326 respectively. In some embodiments, the second output conduit 122, 222, 322 is the input conduit of the third separating junction 132, 232, 332.

In some embodiments, the fifth output conduit 125, 225, 325 is higher than the sixth output conduit 126, 226, 326 in the vertical direction. The first material flowing into the fifth output conduit 125, 225, 325 is more than that flowing into the sixth output conduit 126, 226, 326, while the second material flowing into the fifth output conduit 125, 225, 325 is less than that flowing into the sixth output conduit 126, 226, 326.

In some embodiments, the output from the fifth output conduit 125, 225, 325 is the first product stream 15, 25, 35 which is then output from the first outlet 14, 24, 34. The output from the sixth output conduit 126, 226, 326 is the second product stream 17, 27, 37 which is then output from the second outlet 16, 26, 36. The first material in the first product stream 15, 25, 35 is more than that in the second product stream 17, 27, 37. The second material in the second product stream 17, 27, 37 is more than that in the first product stream 15, 25, 35.

In some embodiments, the first material is oil, while the second material is water.

In some embodiments, the first outlet 14, 24, 34 is vertically higher than the second outlet 16, 26, 36.

According to the requirements of separation effects and the difference of the material combinations in specific separation streams, the number and arrangement of separating junctions, of the input and output conduits in the separating junctions, and of the inlets and outlets, may be adjusted.

In some embodiments, the separating section 13, 23, 33 comprises a fourth separating junction 133, 233, 333 in communication with any combination of the output conduits of other different separating junctions and comprising a seventh output conduit 127, 227, 327 and an eighth output conduit 128, 228, 328. In some embodiments, the any combination of the output conduits of different other separating junctions is the input conduit of the fourth separating junction 133, 233, 333.

In some embodiments, the fourth separating junction 133, 233, 333 is in communication with the combination of the fourth output conduit 124, 224, 324 and the fifth output conduit 125, 225, 325. In some embodiments, the combination of the fourth output conduit 124, 224, 324 and the fifth output conduit 125, 225, 325 is the input conduit of the fourth separating junction 133, 233, 333.

In some embodiments, the separating section 13, 23, 33 comprises a plurality of first separating junctions 130, 230, 330, second separating junctions 131, 231, 331, third separating junctions 132, 232, 332, fourth separating junctions 133, 233, 333, or any combination thereof. In some embodiments, the separating section 13, 23, 33 comprises more than 3, 3 to 5, or more than 5 of the first separating junctions 130, 230, 330, the second separating junctions 131, 231, 331, the third separating junctions 132, 232, 332 and the fourth separating junctions 133, 233, 333.

In some embodiments, the first input conduits 120, 220, 320 of at least one of the first separating junctions 130, 230, 330 is in communication with at least one output conduit of other separating junctions. That is, the at least one output conduit of other separating junctions is the first input conduit 120, 220, 320 of at least one of the first separating junctions 130, 230, 330.

In some embodiments, the apparatus 10, 20 includes one or more other outlets 18, 28, which are used for outputting one or more other production streams 19, 29. In some embodiments, the separation stream 12, 22, 32 includes other materials other than the first and second materials, and one material of the other materials in the other production stream 19, 29 is more than other materials.

In some embodiments, the first outlet 14, 24, 34, the second outlet 16, 26, 36 and the one or more other outlets 18, 28 are located vertically different from each other.

In some embodiments, the apparatus 30 includes a second inlet 310 for receiving a second separation stream 311 which may be different from or identical to the separation stream 32 in material composition, etc.

In some embodiments, the output conduits within each of the separating junctions are located vertically different from each other.

In some embodiments, the present invention relates to an oil and gas production system comprising the apparatus for gravity separation according an embodiment of the present invention. The combination of the separation oil, gas, water and/or solids are input into the apparatus according an embodiment of the present invention, and on the basis of gravity and according to the difference of material densities, are respectively separated into oil, gas, water and/or solid production stream which is mainly or wholly some material.

In some embodiments, the present invention relates to a method for gravity separation, comprising: inputting a separation stream 12, 22, 32 comprising a first material with a first density and a second material with a second density higher than the first density into an inlet 11, 21, 31 of the apparatus 10, 20, 30 according to an embodiment of the present invention; separating the separation stream 12, 22, 32 in the separating section 13, 23, 33 and providing a first product stream 15, 25, 35 and a second product stream 17, 27, 37 comprising less of the first material and more of the second material than the first product stream 15, 25, 35; outputting the first product stream 15, 25, 35 from the first outlet 14, 24, 34; and outputting the second product stream 17, 27, 37 from the second outlet 16, 26, 36.

In some embodiments, the present invention relates to an oil and gas production method comprising the method for gravity separation according an embodiment of the present invention.

The apparatus for gravity separation according an embodiment of the present invention may be triangle, diamond, rectangular, square or the combination of any shapes, and may be made by any material meeting the application requirements, such as alloys like stainless steels, and plastics.

The input and output conduits according to an embodiment of the present invention may be tubes, or any other channels which the separation stream 12, 22, 32 after entering the apparatus 10, 20, 30 can pass through.

In the apparatus and method for gravity separation, the complete separation effect is achieved by the combination of the separation effects of a certain fractal or deforming structure consisting of input and output conduits of the separating junctions and the structure of the plurality of separating junctions, and the apparatus and method for gravity separation can be applied to the separation of two phases such as gas-liquid, liquid-solid, oil-water, or more phases. The fractal structure improves substantially the separating effects over the existing apparatus and method, and reduces greatly the dwelling time of separation stream, the volume and floor area of the apparatus. Additionally, the structure of conduits provides the apparatus with good pressure-resistant effect, hence the apparatus and method may be applied to high-pressure separating application such as the abyssal subsea separation, for example in the abyssal and/or offshore oil and gas production.

### TEST EXAMPLES

The following test examples may provide reference to the skilled in the art for implementing embodiments of the present invention. These examples will not limit the scope of the claims.

### Example 1

An organic glass base sheet with a thickness of 20 mm is processed to form an open flowing channel network, which is a diamond cross network consisting of 9 parallel flowing channels with a length of 185 mm and a spacing of 20 mm, and another 9 parallel flowing channels with the equal length and equal spacing, with an angle of 120 degrees therebetween, wherein all the flowing channels are rectangular with a width of 5 mm and a depth of 6 mm. Another organic glass with the equal thickness, as a cover sheet, is superposed on the side of the channels, and a transparent polyethylene film is lined between the two organic glasses to assist in sealing. Then bolts are used for press the cover sheet and the base sheet, such that the flow channel on the base sheet forms a closed flow channel. Further, one hole with a diameter of 6 mm is made respectively on the four ends (i.e., the upper, lower, left and right ends) of the cover-base sheet structure, which are used as the inlets and outlets of the fluid in communication with the external conduits. The apparatus is placed vertically as an apparatus for gravity separation. The total volume of the flow channels of the apparatus for gravity separation is about 100 mL.

### Example 2

5000 mL tap water is added with 1% wt. of fine sand with a grain size of 100-200 micron and stirred by a magnetic stirrer to an evenly suspending state, so as to form a separation stream. The separation stream is sent respectively from the left and right inlets of the apparatus for gravity separation produced in Example 1 into the apparatus via a diaphragm pump. Under the gravity, the separation stream flows through flowing channel network (the input and output conduits of the separating junctions) to form an upper flowing liquid (a first production stream) and a lower flowing liquid (a second production stream), wherein at 90% of the flow rate of the fed liquid, the upper flowing liquid with a reduced sand content is introduced outside from the upper outlet (a first outlet) of the apparatus, while at 10% of the flow rate of the fed liquid, the lower flowing liquid with a increased sand content is introduced outside from the lower outlet (a second outlet) of the apparatus. The flowing channel network is the separating section of the apparatus for gravity separation, and the cross flowing channels are the separating junctions and the input/output conduits thereof. The main operation conditions and results of five tests are shown in the following Table 1.

TABLE 1

| | Test No. | | | | |
|---|---|---|---|---|---|
| | 1 | 2 | 3 | 4 | 5 |
| Feeding flow rate, mL/s | 4.0 | 6.0 | 8.6 | 9.1 | 11.4 |
| Dwelling Time, seconds | 25 | 17 | 12 | 11 | 9 |
| Flow rate of the upper flowing | 3.6 | 5.4 | 7.7 | 8.2 | 10.3 |
| liquid, mL/s | | | | | |
| Sand content in the upper | 0 | 0 | <0.01% | <0.02% | <0.05% |
| flowing liquid, % wt. | | | | | |
| Flow rate of the lower flowing | 0.4 | 0.6 | 0.9 | 0.9 | 1.1 |
| liquid, mL/s | | | | | |
| Sand content in the lower | ~10% | ~10% | ~10% | ~10% | ~10% |
| flowing liquid, % wt. | | | | | |

Seen from Table 1, in each of the five tests with the dwelling time of 9-25 seconds, the sand content in the upper flowing liquid is smaller than 0.05%, which indicates that more than 95% of the solids therein are separated effectively. Furthermore, when the dwelling time is 17 seconds or longer, the sand content in the upper flowing liquid are nearly zero, which indicates that the apparatus for gravity separation achieves relatively complete separation for the solid-liquid mixture. The test result shows that the apparatus for gravity separation may be a compact and efficient solid-liquid separator.

### Example 3

1000 mL soybean oil is mixed with 2000 mL tap water, and stirred by a magnetic stirrer at a high groove (about 1 meter higher than the inlet of the apparatus produced in Example 1) to an evenly suspending state, so as to form a separation stream. The separation stream is sent under the gravity, respectively from the left and right inlets of the apparatus for gravity separation produced in Example 1 into the apparatus. Under the gravity, the separation stream flows through flowing channel network to form a first production stream (an upper flowing liquid) and a second production stream (a lower flowing liquid), wherein at 33% of the flow rate of the fed liquid, the upper flowing liquid with a reduced water content is introduced outside from an upper outlet (a first outlet) of the apparatus, while at 67% of the flow rate of the fed liquid, the lower flowing liquid with a increased water content is introduced outside from the lower outlet (a second outlet) of the apparatus. The flowing channel network is the separating section of the apparatus for gravity separation, and the cross flowing channels are the separating junctions and the input/output conduits thereof. The main operation conditions and results of four tests are shown in the following Table 2.

TABLE 2

Test No.

| | 1 | 2 | 3 | 4 |
|---|---|---|---|---|
| Feeding flowing rate, mL/s | 2.9 | 4.3 | 6.7 | 12.5 |
| Dwelling Time, second | 34 | 23 | 15 | 8 |
| Flowing rate of the upper | 1.0 | 1.4 | 2.2 | 4.1 |
| flowing liquid, mL/s | | | | |
| Oil content in the upper | >99% | >99% | 90% | 62% |
| flowing liquid, % wt. | | | | |
| Flowing rate of the lower | 1.9 | 2.9 | 4.5 | 8.4 |
| flowing liquid, mL/s | | | | |
| Water content in the lower | >98% | >98% | >98% | >98% |
| flowing liquid, % wt. | | | | |

Seen from Table 2, in all the four tests, the water content in the lower flowing liquid are larger than 98%, which indicates that water therein are separated effectively. In the two tests with the dwelling time of 8 and 15 seconds, the oil content in the upper flowing liquid are 62% and 90% respectively, which indicates that a certain extent of partial separation is achieved as compared to the fed liquid with an oil content of 33%. Furthermore, when the dwelling time is 23-34 seconds, the oil content in the upper flowing liquid is more than 99%, which indicates that the apparatus for gravity separation achieves relatively complete separation for the oil-water mixture. The test result shows that the apparatus for gravity separation may be a compact and efficient oil-water separator.

Although embodiments of the present invention has been described with reference to some embodiments, it should be understood that various variations and modifications may be made. Thus it should noted that the claims are intended to cover all the modifications and variations within the concept and scope of the present invention.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus for gravity separation, comprising:
an inlet for receiving a separation stream;
a separating section in communication with the inlet, for separating the separation stream and providing a first product stream and a second product stream, and comprising a first separating junction comprising a first input conduit, a first output conduit and a second output conduit, a second separating junction in communication with the first output conduit and comprising a third output conduit and a fourth output conduit, and a third separating junction in communication with the second output conduit and comprising a fifth output conduit and a sixth output conduit;
a first outlet for outputting the first product stream; and
a second outlet for outputting the second product stream.

2. The apparatus of claim 1, wherein the separating section comprises a fourth separating junction in communication with any combination of the output conduits of other different separating junctions and comprising a seventh output conduit and an eighth output conduit.

3. The apparatus of claim 2, wherein the separating section comprises a plurality of the first separating junctions, the second separating junctions, the third separating junctions, the fourth separating junctions, or any combination thereof.

4. The apparatus of claim 3, further comprising one or more other outlet for outputting one or more other product stream.

5. The apparatus of claim 4, wherein the first outlet, the second outlet and the one or more other outlet are located vertically different from each other.

6. The apparatus of claim 3, wherein at least one of the first input conduits is in communication with at least one output conduits of other separating junctions.

7. The apparatus of claim 1, wherein the first outlet is located vertically higher than the second outlet.

8. The apparatus of claim 1, further comprising a second inlet for receiving a second separation stream.

9. The apparatus of claim 1, wherein the output conduits in each of the separation junctions are located vertically different from each other.

10. An oil and gas production system comprising the apparatus of claim 1.

11. A method for gravity separation, comprising:
inputting a separation stream comprising a first material with a first density and a second material with a second density higher than the first density into an inlet of an apparatus comprising:
an inlet for receiving a separation stream;
a separating section in communication with the inlet, for separating the separation stream and providing a first product stream and a second product stream, and comprising a first separating junction comprising a first input conduit, a first output conduit and a second output conduit, a second separating junction in communication with the first output conduit and comprising a third output conduit and a fourth output conduit, and a third separating junction in communication with the second output conduit and comprising a fifth output conduit and a sixth output conduit;
a first outlet for outputting the first product stream; and
a second outlet for outputting the second product stream;
separating the separation stream in the separating section and providing a first product stream and a second product stream comprising less of the first material and more of the second material than the first product stream;
outputting the first product stream from the first outlet; and
outputting the second product stream from the second outlet.

12. The method of claim 11, wherein the first material is oil and the second material is water.

13. The method of claim 11, wherein the separation stream comprises solid, liquid, gas, or any combination thereof.

14. An oil and gas production method comprising the method of claim 11.
